(19) United States
(12) Patent Application Publication
(10) Pub. No.: US 2016/0250701 A1
(43) Pub. Date: Sep. 1, 2016

(54) MACHINING HEAD FOR A GEAR CUTTING MACHINE AND METHOD FOR TOOTHING A WORKPIECE, IN PARTICULAR A WORM SHAFT OR TOOTHED RACK

(71) Applicant: Liebherr-Verzahntechnik GmbH, Kempten/Allgaeu (DE)

(72) Inventor: Hansjoerg GEISER, Wiggensbach (DE)

(21) Appl. No.: 15/053,905

(22) Filed: Feb. 25, 2016

(30) Foreign Application Priority Data
Feb. 26, 2015 (DE) 10 2015 002 362.4

(51) Int. Cl. B23F 5/20; B23F 5/08; B23F 13/04

(52) U.S. Cl. CPC B23F 5/205; B23F 13/04; B23F 5/08

(57) ABSTRACT

The present disclosure relates to a machining head for a gear cutting machine, in particular a hobbing or hob grinding machine, for toothing a workpiece, in particular a worm shaft or a toothed rack, wherein the machining head comprises at least two tool spindles arranged one beside the other.

### CROSS REFERENCE TO RELATED APPLICATION

This application claims priority to German Patent Application No. 10 2015 002 362.4, entitled “Machining Head for a Gear Cutting Machine and Method for Toothing a Workpiece, in Particular a Worm Shaft or Toothed Rack,” filed on Feb. 26, 2015, the entire contents of which is hereby incorporated by reference in its entirety for all purposes.

### TECHNICAL FIELD

This present disclosure relates to a machining head for a gear cutting machine, in particular a hobbing or hob grinding machine, for toothing a workpiece, in particular a worm shaft or a toothed rack.

### BACKGROUND AND SUMMARY

A toothed rack is a vertically mounted technical device with teeth and mostly is used within a rack-and-pinion drive.

Worm gear units are screw rolling gear units which consist of a pairing of a worm (worm shaft) and a helically toothed worm gear meshing therein. In most applications, the axes of worm shaft and worm gear are at right angles to each other. These gear units are used where high reduction ratios and/or a self-locking feature are called for. The drive of the gear unit usually is effected via the worm.

Due to the function-related relative movements in screw rolling gear units, a sliding movement takes place above all between the flanks of worm and worm gear, so that worm gear units have a low efficiency at high gear ratios at the same time. To keep the friction in the gear unit as low as possible, high demands are placed on the manufacturing accuracy and surface quality of the tooth flanks.

In general, the worm is a special form of a helically toothed gearwheel. The angle of the helical toothing is so large that one or several teeth helically wind into the shaft axis. Worm gears may be manufactured on gear cutting machines, as for their manufacture a rolling coupling between the tool (hob) and the workpiece (worm gear) is necessary. The hob used should be identical in shape with the worm (worm shaft) of the gear unit, apart from certain correction variables. Worm gears frequently are made of plastic, brass or bronze alloys.

The associated worm (worm shaft) likewise can be manufactured on a hobbing machine or be machined on a hob grinding machine, when certain marginal conditions are given. Since worm gears frequently are made of hardened steel, the same very often still are ground after the heat treatment. It furthermore is possible, however, to also manufacture worms on universal milling machines with dividing equipment or on correspondingly upgraded lathes. Further methods include the hob peeling or whirling of worms, wherein the disadvantage of these methods is to be seen in the expensive special tools adjusted especially to the workpiece to be manufactured. Depending on the required accuracy, dimensions, number of teeth, modulus and flank shape as well as the quantities of worms to be manufactured, a corresponding method and a corresponding machine is chosen.

When manufacturing worms on hobbing machines according to the prior art as shown in FIG. 1 and FIG. 2, one or more special side milling cutters 1, 2 usually are clamped onto the tool holder mandrel 3 instead of a hob. For quality reasons, the finishing cutter 1 mostly is mounted closer to the tool drive motor 4. The milling cutters 1, 2 are positioned by means of the Z- and V-axes and one after the other are brought in engagement by advance along the X-axis.

The A-axis serves for adjusting the helix angle γm of the worm 5. The Z-axis in this case serves for positioning the milling head 6.

The worm 5 to be manufactured or to be machined is clamped into the workpiece clamping device 8 and frequently supported at its upper end via a steady rest 7. Due to the helix angle γm of the worm 5, the machining head 6 of the gear cutting machine requires a larger swiveling range, in order to appropriately position the side milling cutter 1, 2 relative to the worm. A serious disadvantage of this embodiment consists in that because of impending collisions the worm 5 cannot accommodate in its center via a tip. As is quite clearly visible in FIG. 2, the upper tool 1 would collide with a tip for accommodating a workpiece, when the lower tool 2 is in engagement with the worm 5. In addition, the tool mandrel length 3 should be adapted in dependence on the worm length 5, in order to prevent an unwanted collision of the tool 1 with the worm 5, when the tool 2 is machining the worm 5 close to the clamping device 8.

The distance of the tool 1 from the machining head main bearing 9 should be chosen correspondingly large, so that no collision can occur here. Especially with small tool diameters and long worms 5 the tool mandrel 3 can become quite thin, which has a disadvantageous effect on the stability. The support via the steady rest 7 only permits reduced machining parameters. In addition, a steady rest 7 is suitable for use in dry milling only to a limited extent. The cantilevered support of the steady rest 7 has distinct disadvantages as compared to clamping/supporting a workpiece on two sides.

The present disclosure searches for a solution, in order to overcome the above problems during toothing or machining of a workpiece, in particular of a worm shaft or a toothed rack.

This object is solved by a novel machining head for a gear cutting machine for toothing a workpiece. Advantageous configurations of the machining head are the subject-matter of the dependent claims following the main claim.

According to the present disclosure, there is proposed a machining head for a gear cutting machine, in particular a hobbing or hob grinding machine, for toothing and machining a workpiece, which may be in the form of a worm shaft for a worm gear unit or a toothed rack. In a way essential for the present disclosure, the machining head is equipped with at least one additional tool spindle, and the machining head hence comprises at least two tool spindles arranged one beside the other for accommodating corresponding tools. Accordingly, it no longer is necessary to accommodate several tools on one and the same spindle, although this should of course not be excluded for the novel machining head.

The division of the machining tools on two separate tool spindles arranged one beside the other provides far-reaching advantages in the tooth-machining of workpieces. In particular in workpieces of great overall length, an additional fixation can be effected at the tip of the workpiece beside the conventional clamping of the workpiece on the machine table, due to the division of the tools on separate tool axles, whereby the workpiece can be accommodated much more stably. The machining quality can distinctly be improved thereby. In addition, the more stable fixation allows larger advances or feed rates, whereby the machining time can noticeably be reduced. Furthermore, a limited spindle length is sufficient to accommodate a single tool, which ensures a more stable tool travel even without counter bearing.

The workpiece may be clamped in a vertical longitudinal direction.

The arrangement of the at least two tool spindles may be substantially parallel to each other. The drive of the at least two tool spindles can be effected via separate motors or alternatively via a common motor. When using a common drive unit, the division of moments may be achieved via an interposed transfer gear. When using separate drive units, in particular direct drives are suitable for the individual spindles. The machining head optionally comprises a guiding device for a shiftable accommodation of the machining head within a gear cutting machine. The axis of rotation of the tool spindle in this case may extend transversely to the shift direction of the machining head achievable by means of the guiding device.

The at least two tool spindles can be provided with appropriate tool mandrels which allow mounting of the tools on the spindles with identical center distances to the shaft bearings or alternatively with different center distances to the shaft bearing. This means that the tools can be mountable offset to each other, in order to avoid an overlap and collision of their working radii. In this connection, at least one of the tool spindles may have an appropriate mandrel for variably mounting the tool, in order to flexibly adapt the center distance to the shaft bearing.

The tools may be mounted with identical center distance. However, when tools with large diameter are used, an offset arrangement on the spindles extending in parallel possibly can be expedient, as otherwise the large diameters and the possibly overlapping working radii can lead to a collision of the two tools. Due to the offset arrangement, tools with overlapping diameter can be mounted and operated.

The tool spindles in particular are suitable for mounting disk-shaped tools, what is conceivable are disk-shaped milling and/or grinding tools; for example, a combination of roughing and finishing tool can be mounted on the at least two tool spindles. Furthermore, the use of so-called tool sets also would be conceivable, which can be composed of several individual disk-shaped tools.

Beside the machining head, the present disclosure relates to a gear cutting machine, in particular a hobbing or hob grinding machine, with at least one machining head according to the present disclosure. The gear cutting machine accordingly is characterized by the same advantages and properties as the machining head according to the present disclosure.

In an advantageous configuration of the gear cutting machine, the same comprises at least one tip, in particular a tip mounted on a ball bearing, for fixing the workpiece clamped on a machine table during machining with the machining head. Other than known from the prior art, workpieces with a certain axial length accordingly can be clamped on the tool table with sufficient stability and thereby provide for gear cutting in a stable and quality-preserving way. Alternatively or in addition, the fixation via at least one steady rest likewise is conceivable.

Beside the gear cutting machine according to the present disclosure, the present disclosure furthermore relates to a method for toothing a workpiece, in particular a worm shaft or toothed rack, with the machining head according to the present disclosure or the gear cutting machine according to the present disclosure. The method according to the present disclosure is characterized in that the workpiece is toothed or machined sequentially or in parallel by using disk-shaped tools mounted on different tool spindles of the machining head.

According to the present disclosure, disk-shaped milling and/or grinding tools may be used. According to an embodiment, a disk-shaped roughing tool, which may be a roughing cutter, is accommodated on a tool spindle, while on at least one further tool spindle a finishing tool, in particular a finishing cutter, is mounted. With the first tool axle the workpiece initially is roughly pre-machined by means of the roughing tool and thereafter re-machined with the finishing tool of the at least one second tool spindle. What is, however, also possible is machining of a workpiece with the at least two tool spindles at the same time. For example, two adjacent gaps of the workpiece can be machined at approximately the same time with corresponding tool diameters, wherein one gap per roughing process is pre-toothed, while a previously machined gap approximately at the same time is re-machined by finishing. Due to the distance of the tool axles, the machining of two gaps, i.e. the engagement of the tools, is not entirely synchronous. By suitably choosing the tool diameters, however, it can be achieved that two gaps are machined in one process step, wherein the tools are not in engagement quite synchronously, but offset by the tool axle distance and hence also slightly offset “in terms of time.”

Optionally, when during the execution of the method the workpiece may be additionally fixed by a tip and/or a steady rest, so that machining thereby can be carried out with a larger feed rate or larger advance.

Changing between the machining tools of the at least two tool spindles in particular is effected by shifting the machining head in V-direction relative to the machine column in V-direction of the CNC machine.

Furthermore, it is conceivable that at different center distance to the shaft bearing of the mounted tools an adjustment of the machining head is made for using the respective tool in Z-direction or vertical direction.

When machining worm shafts, the machining movement, for example the milling movement, may be effected by advancing the tools towards the workpiece in X-direction, i.e. the machine column is linearly moved towards the clamped workpiece, and by a feed in Z-direction, possibly in combination with a coupled rotary movement of the workpiece around the C-axis. Milling is continued, until milling of one flight is completed. In the case of multi-flight worms, the individual flights are machined sequentially. The helix angle is adjusted via the A-axis, about which the machining head is pivotable with respect to the machine column.

When machining toothed racks, the machine table is standing still, i.e. there is no movement of the workpiece around the C-axis. The machining movement, in particular the milling movement, is effected via a movement of the tool along the V-axis. After a gap is machined, the machining head is moved upwards or downwards along the Z-axis in vertical direction and the next tooth gap is machined.

After at least two side milling cutters are mounted on the machining head, a roughing and a finishing step can be carried out with the two milling cutters in one machining step for adjacent tooth gaps. The position of the tools relative to each other is adjusted via special tool holders. These tool holders should differ in their length exactly by the gap distance of the tooth gaps. In the case of tool sets, the length of the tool holders should be chosen corresponding to the number of tool sets and the tooth gap machined therewith.

Further advantages and properties of the present disclosure will be explained in detail below with reference to an exemplary embodiment illustrated in the Figs.

### BRIEF DESCRIPTION OF THE FIGURES

FIG. 1 shows a side view of a CNC gear cutting machine with conventional machining head.

FIG. 2 shows a front view of the conventional machining head of the machine of FIG. 1.

FIG. 3 shows a schematic representation of the engagement angle of a tool for manufacturing a grinding shaft.

FIG. 4 shows the gear cutting machine according to the present disclosure with novel machining head.

FIG. 5A shows a front view of the grinding machine according to FIG. 4 for illustrating the tool change.

FIG. 5B shows an additional front view of the grinding machine according to FIG. 4 for illustrating the tool change.

FIG. 6 shows a detail view of the machining head according to the present disclosure as shown in FIGS. 4, 5A and 5B.

### DETAILED DESCRIPTION

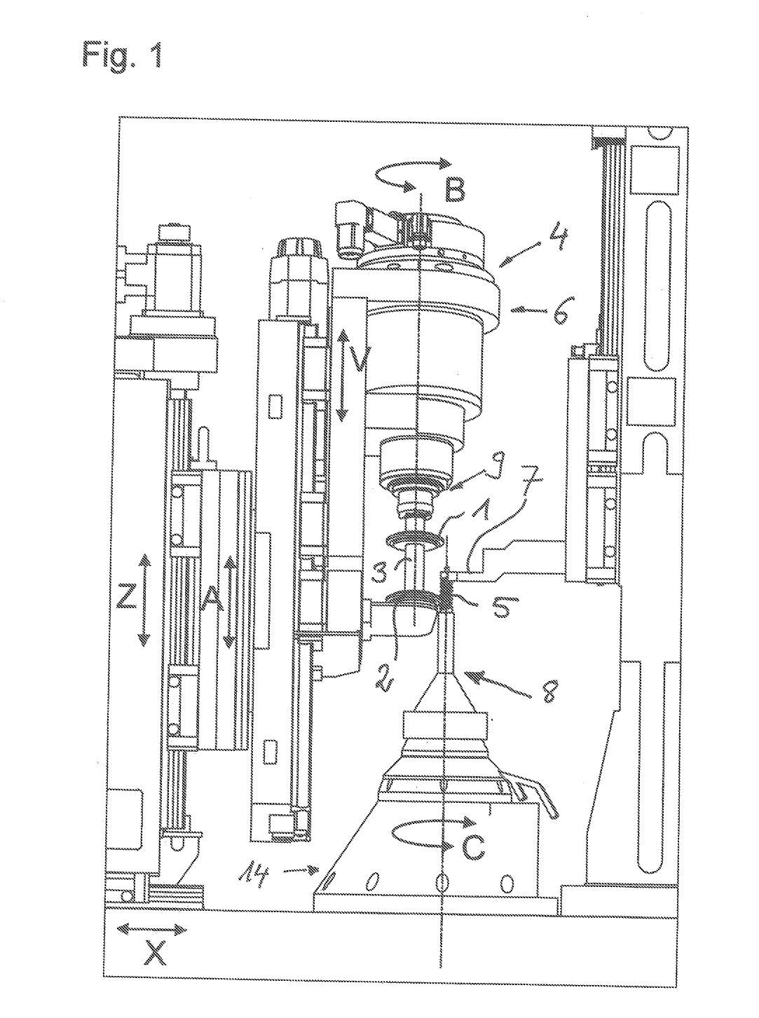

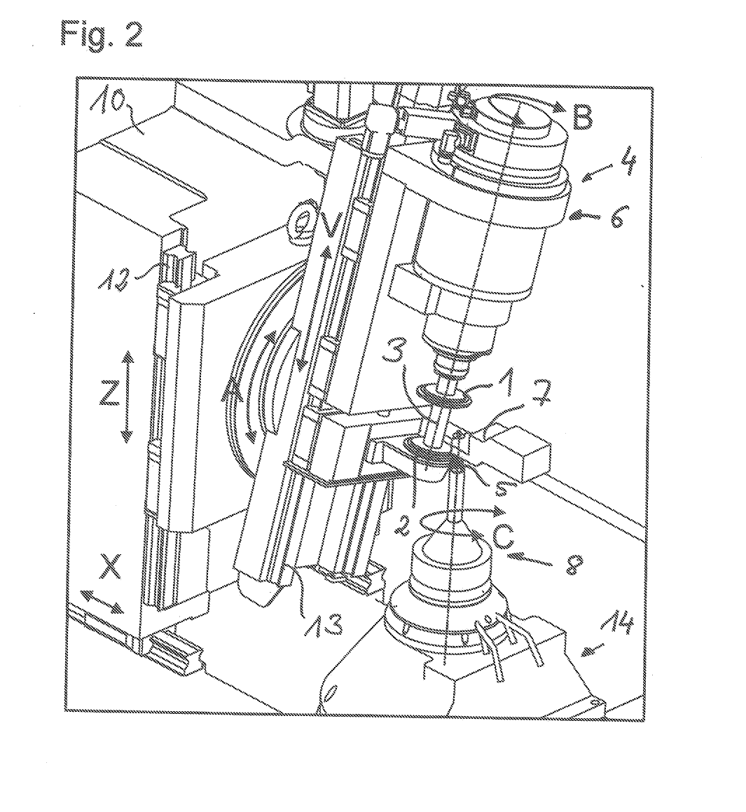

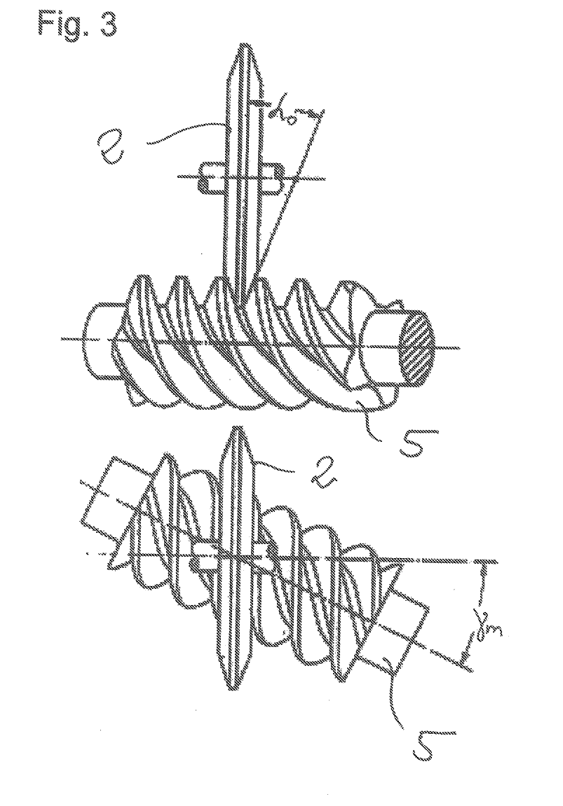

FIGS. 1, 2 have already been discussed in detail in the introductory part of this description. FIG. 3 shows a worm shaft 5 with a side milling cutter 2 in engagement. The flank angle of the side milling cutter 2 is designated with the angle α0, while the helix angle of the worm shaft 5 is designated with γm.

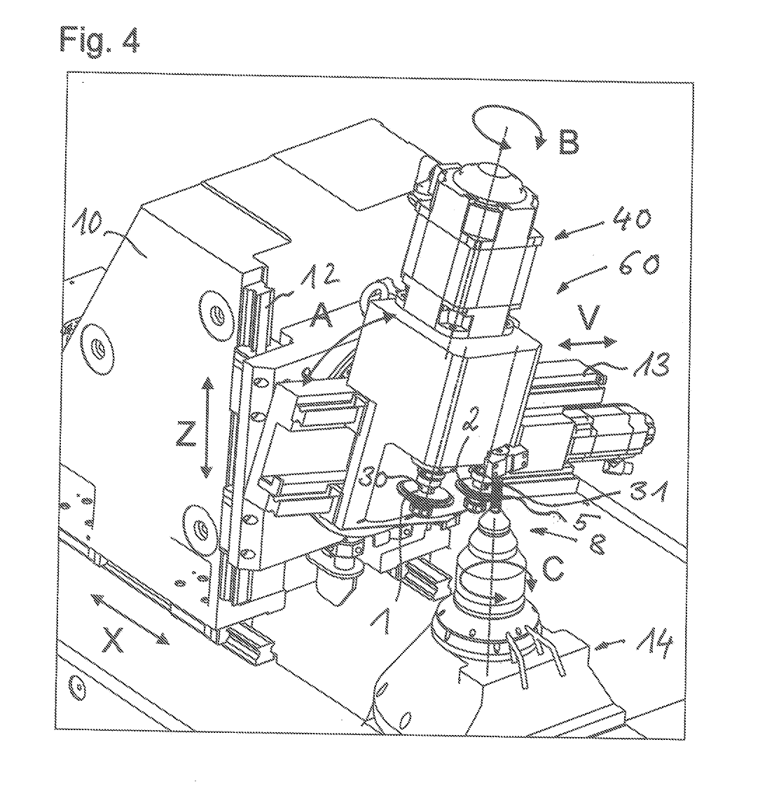

FIG. 4 shows a perspective view of the gear cutting machine according to the present disclosure with the machining head 60 of novel construction. Except for the machining head 60, the illustrated gear cutting machine corresponds to a known hob and profile grinding machine with the degrees of freedom necessary for machining. In detail, the CNC machine can perform the indicated movements A, B, C, V, X, Z, wherein the X-axis designates the radial movement of the column carriage 10 in direction of the vertically clamped workpiece 5, V designates the tangential movement or shift movement of the tool 1, 2 or the machining head 60 by means of the tangential carriage 13 relative to the column carriage 10, Z designates the shift movement of the machining head 60 along the axial carriage 12 of the column carriage 10 in vertical direction, B designates the rotary movement of the tool spindles 30, 31, C designates the rotary movement of the workpiece 5, and A designates the swivel movement of the machining head 60 relative to the machine column 10.

On the tangential carriage 13 of the gear cutting machine, the conventional machining head 6 now has been replaced by the novel machining head 60. The machining head 60 likewise is shiftable in V-direction on the carriage 13. In addition, the machining head 30 has a motor 40 for driving the separate tool spindles 30, 31, which are arranged parallel to each other and are vertical to the shift axis of the tangential carriage 13. The shift direction now extends transversely to the axes of rotation B1, B2 of the spindles 30, 31. Within the machining head 30, i.e. within the head housing, the driving force of the common drive motor 40 is split up on the two tool axles B1, B2. Pivoting the tools 1, 2 and the machining head 60 relative to the machine column 10 jointly is effected via the pivot axis A-axis.

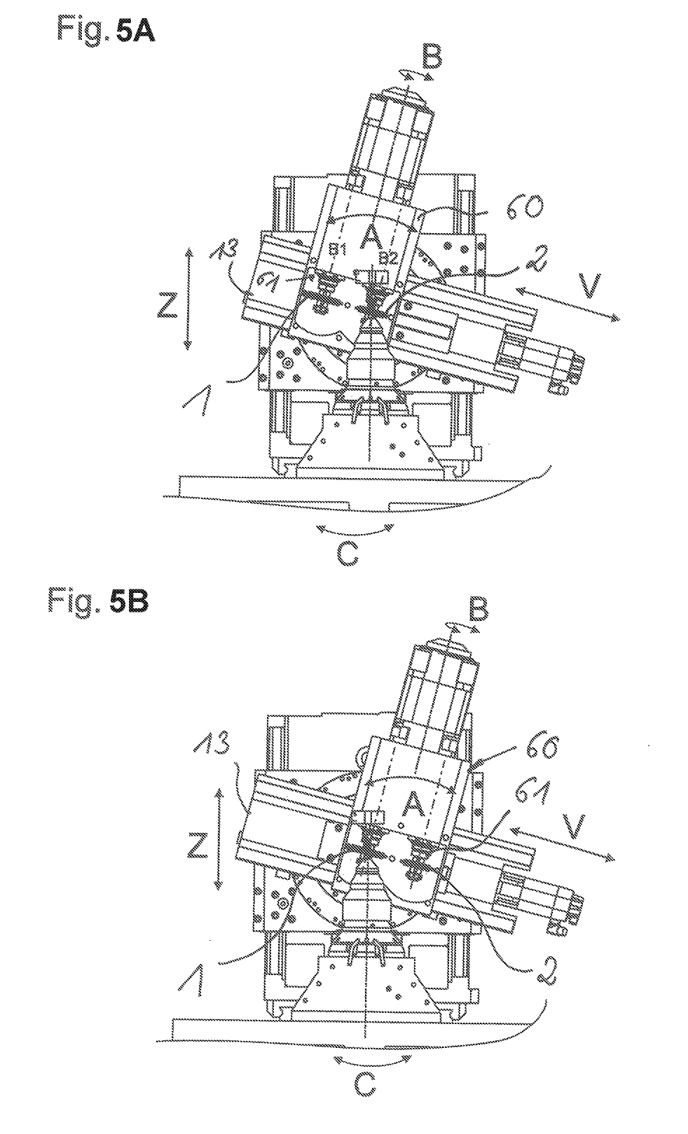

Changing between the machining tools 1, 2 for machining the worm shaft 5 clamped on the machine table 14 by means of the holding fixture 8 is effected by shifting in direction of the V-axis by means of the tangential carriage 13. In FIG. 5A, the worm shaft 5 initially is pre-machined with the disk-shaped roughing cutter 2 clamped on the tool spindle 31. For the finishing process, the disk-shaped finishing cutter 1 on the tool spindle 30 is required. For this purpose, the machining head 60 is shifted in V-direction, until the finishing cutter 1 is brought in engagement with the worm shaft 5.

The milling movement both for the roughing and for the finishing operation is effected by advancing the side milling cutters 1, 2 towards the workpiece 5 in X-direction and by a feed in Z-direction. In addition, a coupled rotary movement of the workpiece 5 is effected around the C-axis. The helix angle γm of the worm shaft 5 can be adjusted via the pivot axis A. Milling is continued, until one flight is completed. In multi-flight worm shafts, one flight after the other is machined in this way.

As is shown in FIGS. 4, 5A, 5B and 6, both tools 1, 2 are arranged with identical distance to the shaft bearing 61 of the machining head 60, i.e. both tools 1, 2 are mounted on the shafts 30, 31 with identical axial distance to the upper edge of the machining head. When disk-shaped tools 1, 2 with large diameter are used, the cutter distance to the machining head main bearing 61 can be chosen differently for each cutter 1, 2, in order to avoid collisions due to the overlapping radii of the disk-shaped tools 1, 2. The advantages of large milling diameters thereby will take effect, without having to choose the distances of the two tool spindles 30, 31 to each other too large.

In addition, the shape of the machining head 60 provides for a short distance of the mounted tools 1, 2 to the machining head main bearing 61. The tools thereby can be clamped in an extremely stable way, without a counter bearing of the tool spindles 30, 31 becoming necessary. In this arrangement the tools 1, 2 do not mutually influence each other in engagement, as they are not arranged on a common milling arbor 3.

When both tools 1, 2 are mounted on the tool spindles 30, 31 with different distance to the main bearing 61 of the machining head 30, a tool change not only requires shifting around the V-axis, but the tool 1, 2 in addition should be brought into the appropriate engagement position via the Z-axis along the axial carriage 12.

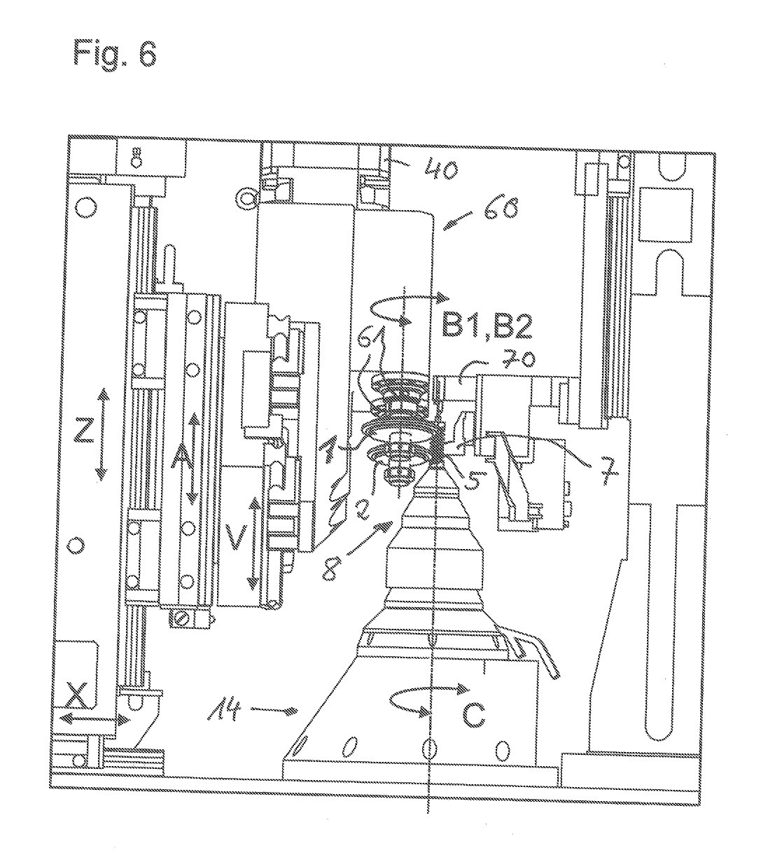

In FIG. 6 it can clearly be seen that the cleared working space in extension of the worm shaft 5 still can be used very well, in order to for example place a tip 70 in the center of the worm 5. In addition, the worm shaft 5 also can be supported by means of a steady rest 7 as before. Thus, the workpiece 5 can be accommodated much more stably, whereby either its machining quality is improved or the machining time can be reduced by employing larger feed rates or advances.

Alternatively, toothed racks also can be machined with the machining head 60 according to the present disclosure. When machining toothed racks, the table 14 is standing still, i.e. the clamped toothed rack does not rotate around the workpiece axis C. The machining movement, in particular the milling movement, for toothing the toothed rack is effected via a movement of the tool, which may be the side milling cutter 1, 2, along the V-axis. After a tooth gap has been machined completely, the machining head 60 is moved upwards or downwards along the Z-axis, in order to bring the tool in engagement with the next tooth gap. Each tooth gap can alternately be machined with the first and the second tool 1, 2.

Alternatively, the tools 1, 2 also can be brought in engagement with adjacent tooth gaps of the toothed rack in one process step. For example, a tooth gap is pre-milled roughly with a roughing cutter 2, while the second finishing cutter 1 re-machines a previously pre-milled tooth gap by finish machining. The position of the cutters 1, 2 relative to each other is adjusted via special tool holders, which adjust the offset of the cutters 1, 2 to each other exactly by the gap distance of the tooth gaps.

1. A machining head for a gear cutting machine for toothing a workpiece, wherein the machining head comprises at least two tool spindles arranged one beside the other.

2. The machining head according to claim 1, wherein the workpiece is a worm shaft or a toothed rack, wherein the gear cutting machine is a hobbing or hob grinding machine, and wherein the at least two tool spindles extend substantially parallel to each other, the machining head further comprising a guiding device for a shiftable accommodation within the gear cutting machine, wherein axes of rotation of the tool spindles are oriented transversely to a shift direction.

3. The machining head according to claim 1, wherein the at least two tool spindles are driven by separate motors or by a common motor with a succeeding transfer gear.

4. The machining head according to claim 1, wherein at least one tool mandrel of the at least two tool spindles provides for mounting a tool with a variable center distance to a shaft bearing of the tool spindle.

5. The machining head according to claim 4, wherein the tool of the at least two tool spindles comprises one or more tools, wherein the one or more tools are mountable with identical and/or different center distances to their respective shaft bearing.

6. The machining head according to claim 1, wherein disk-shaped tools can be accommodated on the tool spindles, wherein the disk-shaped tools are milling and/or grinding tools.

7. The machining head according to claim 6, wherein tools with identical or different diameters can be accommodated on the tool spindles, wherein the diameters of the tools overlap.

8. A gear cutting machine for toothing a workpiece comprising:
a machining head, wherein the gear cutting machine is a hobbing or hob grinding machine, wherein the machining head comprises at least two tool spindles arranged one beside the other, wherein the workpiece is a worm shaft or a toothed rack.

9. The gear cutting machine according to claim 8, wherein a shift movement of the machining head by means of the tangential carriage extends in a V-direction transversely to an axis of rotation of the tool spindles.

10. The gear cutting machine according to claim 9, wherein a tip mounted on a ball bearing is provided for fixing the workpiece during machining with the machining head and/or a steady rest is provided for fixing the workpiece during machining with the machining head.

11. A method for toothing a workpiece with a gear cutting machine, the gear cutting machine comprising a machining head:
with at least two tool spindles arranged one beside the other;
wherein the workpiece is a worm shaft or a toothed rack;
wherein the workpiece is toothed sequentially or approximately at the same time by using disk-shaped tools mounted on different tool spindles of the machining head, wherein the disk-shaped tools are milling and/or grinding disks.

12. The method according to claim 11, wherein the tool spindle accommodates a disk-shaped roughing tool, wherein a second tool spindle accommodates a finishing tool.

13. The method according to claim 11, wherein tool sets are mounted on one or both tool spindles.

14. The method according to claim 11, wherein during machining the workpiece is fixed by a tip and/or a steady rest.

15. The method according to claim 11, wherein a change of the disk-shaped tool is effected by a shift movement of the machining head in a V-direction.

16. The method according to claim 11, wherein when tools are mounted with different center distances to the shaft bearing an adjustment of the machining head is effected in a Z-direction or a vertical direction.

17. The method according to claim 16, wherein for toothing a worm shaft a machining movement is effected by advancing the tool towards the workpiece in an X-direction and by feeding in the Z-direction, the machining movement in combination with a coupled rotary movement of the workpiece around a C-axis.

18. The method according to claim 11, wherein for toothing a toothed rack the machining movement is effected via a movement of the tool along a V-axis with a machine table standing still and after machining of a tooth gap the machining head is moved upwards or downwards along a Z-axis, in order to machine the next tooth gap.

19. The method according to claim 18, wherein by means of at least two tools clamped on separate tool spindles a tooth-machining of adjacent tooth gaps, a roughing step and a finishing step of the adjacent tooth gaps of the toothed rack are carried out in one process step.

20. The gear cutting machine of claim 8, wherein at least one tool mandrel of the at least two tool spindles provides for mounting a tool with a variable center distance to a the shaft bearing of the tool spindle, wherein the tool of the at least two tool spindles comprises one or more tools, wherein the one or more tools are mountable with identical and/or different center distances to their respective shaft bearing.
